(19) United States
(12) Patent Application Publication
(10) Pub. No.: US 2008/0116149 A1
(43) Pub. Date: May 22, 2008

(54) System and method for the disinfection of irrigation water

(76) Inventors: Paul H. Dick, San Jose, CA (US); Michael Weber, Sunnyvale, CA (US); Robert L. Cooke, Ridgefield, WA (US); Ram Prasad, Saratoga, CA (US); Mukund Dusey, Livermore, CA (US)

Correspondence Address: CARR & FERRELL LLP, 2200 GENG ROAD, PALO ALTO, CA, 94303, US

(21) Appl. No.: 11/973,151

(22) Filed: Oct. 5, 2007

Related U.S. Application Data
(60) Provisional application No. 60/849,599, filed on Oct. 5, 2006.

(51) Int. Cl. C02F 1/78

(52) U.S. Cl. 210/760; 210/739; 210/85; 210/87; 210/120; 210/764; 422/186.14; 422/28

(57) ABSTRACT

The present invention provides a system and method for the disinfection of irrigation water. Irrigation water is exposed to ozone, which disinfects and flocculates the water for improved removal of bacterial contamination. One or more ozone generators produce ozone gas that is injected into the flow of irrigation water at one or more points in an irrigation water treatment system. The ozone may be hyper concentrated, and the mixing of ozone and water may be optimized so that the maximum amount of water is exposed to a concentration of ozone that is high enough to disinfect the water over the period of contact. Ozonated water is then delivered to farm fields. No harmful residues remain in the water or soil after treatment.

### CROSS-REFERENCE TO RELATED APPLICATIONS

This application claims benefit of U.S. Patent Application Ser. No. 60/849,599, titled “Method and Apparatus for the Disinfection of Irrigation Water,” filed on Oct. 5, 2006 (Attorney Docket No. PA3982PRV), which is incorporated by reference herein.

### BACKGROUND OF THE INVENTION

1. Field of the Invention

This invention relates to agricultural irrigation, and particularly to the treatment of irrigation water.

2. Description of Related Art

Water is used to irrigate agricultural fields, such as fields of fruits, vegetables, leafy greens and other natural or perishable products. A common watering system for delivering water to a field includes a water source, a pump, optional filtration, pipes for carrying the water to one or more fields (which may be some distance away from the water source), and sprinkler heads or drip lines. Irrigation water generally comes from wells, from reservoirs filled by wells, from irrigation canals, from local streams or from irrigation ponds.

The water from these sources may or may not be filtered before being dispersed. For example, well water distributed to a sprinkler system may not need filtering to remove solid particles, but if the same water source is used to water a field using drip irrigation, a filter may need to be installed. Commonly used filters include sand filters and Y-strainers.

There is increasing concern about produce contaminated with biological pathogens, such as E. Coli, which can cause serious illness or death in people consuming produce. One possible source of produce contamination is the irrigation water used on the farm fields, particularly water from open water bodies, such as reservoirs or canals. Contamination may come from bird or animal excrements, run-off from pastures, or dead animals. There are also many other ways for water to become contaminated by biological pathogens, even if the water comes from a seemingly pristine source. Pathogens may enter an irrigation system or plumbing, and be spread to the fields and produce when water flows through the system. Pathogens may also grow inside the equipment and pipes; it is often observed that components of watering systems are “slimy” on the inside.

If the water is unfiltered, microorganisms may be distributed to fields and produce unhindered. Filters such as sand filters may work very well for removing larger dissolved and non-dissolved solids (in the range of about 20-30 microns and above) from the water; however, these filters are typically ineffective for removing or destroying the smaller biological contaminants normally found in the 0.02-2.0 micron range. It has been found that these biological contaminants can be passed into the fruits and vegetables, causing sickness and even death of persons who consume the contaminated produce.

Though chlorine is commonly used to disinfect water, it is not typically used to disinfect irrigation water because of the problematic residual chlorine build-up in the soil and ground water that occurs if chlorine is applied continuously. There is also growing concern about the discharge of chlorine and the by-products of chlorination into the environment more generally.

Thus, currently available tools for disinfecting irrigation water are not sufficiently effective to prevent bacterial contamination of produce that can endanger public health.

### SUMMARY OF THE INVENTION

The present invention provides a system and method for the disinfection of irrigation water. Irrigation water is exposed to ozone, which disinfects and flocculates the water for improved removal of bacterial contamination. One or more ozone generators produce ozone gas that is injected into the flow of irrigation water at one or more points in an irrigation water treatment system. The ozone may be hyper concentrated, and the mixing of ozone and water may be optimized so that the maximum amount of water is exposed to a concentration of ozone that is high enough to disinfect the water over the period of contact. Ozonated water is then delivered to farm fields. No harmful residues remain in the water or soil after treatment.

### BRIEF DESCRIPTION OF THE DRAWINGS

FIG. 1 is a block diagram showing an exemplary system for the disinfection of irrigation water according the present invention.

FIG. 2 is block diagram showing another exemplary system for the disinfection of irrigation water according to the present invention.

FIG. 3 is a block diagram of an exemplary ozone control system that may be used in some embodiments of the present invention to monitor and adjust the ozone concentration in the water.

FIG. 4 is flow chart showing an exemplary method for the disinfection of irrigation water according to the present invention.

### DETAILED DESCRIPTION OF THE INVENTION

The present invention provides a system and method for the disinfection of irrigation water. While “disinfection” may refer to the complete removal of pathogens, even an incomplete reduction in pathogen count (also called “CFU,” or colony-forming units) may be beneficial, because of the concurrent reduction of the likelihood that numbers of pathogenic microorganisms will build up to dangerous levels. Thus, we define “disinfection” as a reduction in pathogen count, whether the reduction is partial or complete.

Embodiments of the present invention employ ozonated water to reduce pathogen counts. “Ozonated water” is water that has been treated with ozone gas, whether or not residual ozone is present after treatment. Ozone dissolved into irrigation water can be used as an effective sanitizer of the water before its application to farm fields. Ozonated water may also clean the water distribution system of pipes, tanks, etc. Ozonation may occur before and/or after any filtration treatments. Unlike treating water with chlorine or other oxidizers, ozonation leaves no hazardous residues.

While ozone is more efficient than other oxidizers (for example, ozone is up to 3000 times as efficient as chlorine), it does not kill pathogens immediately. A time T (expressed in minutes) of exposure to a given concentration of ozone, C (expressed in ppm), is required to kill microorganisms. By multiplying C and T, a value called “CT” is obtained. A given CT corresponds to a kill rate that could range from a one-log reduction in pathogen count to the complete elimination of pathogens. The higher the CT, the more complete the removal of microorganisms. Generally, at least a two- to three-log reduction of pathogens is desired; such a reduction requires CT values of at least 0.1. For greater reductions in pathogen counts, required CT values may be larger than 1.0. Embodiments of the present invention provide a sufficiently high CT to kill pathogens effectively. Simply injecting ozone into the irrigation water stream may not achieve sufficiently high CT values.

An exemplary embodiment comprises a water source, one or more pumps for extracting water from the source and providing sufficient water pressure for ozonation and transport of water to the field, a means for ozonating water to achieve a CT of at least 0.1 and preferably 2.0, a means for transporting the water to one or more farm fields, and a means for distributing the water to the soil near the plants' roots. Various embodiments optionally include any numbers of the following in any combination: a tank for ozonated water storage, a filter, a splitter for dividing the water flow into a main stream and a side stream, a combiner for combining an ozonated side stream of water with a main stream, an ozone generator, an ozone concentrator, an injector for ozone gas, an injector for ozonated water, a mixer for thoroughly combining ozone gas with water, a contacting means of sufficient volume to provide a contact time T to achieve a CT value of at least 0.1 either by itself or in combination with an ozonated water storage tank and/or transport pipes, a means for removal of excess ozone, a means for measuring ozone concentration in water, a means for measuring water flow, and a means for controlling the ozone concentration in water so that a desired CT may be achieved regardless of changes in the water flow rate.

Not every element listed is necessary to each embodiment of the invention; the components and configuration of a particular embodiment may depend on parameters such as flow rates in the irrigation system, and the level of contamination of the water. In some cases a choice between available elements may be arbitrary, depending, for example, on availability or price. Once ozone is dissolved in water, it continues to act as a disinfectant while the water is stored or transported, until it naturally decays. One skilled in the art will be able to take ozone decay rates into account in determining the properties needed in the contacting means, or in determining the layout of ozonated water storage tanks and transport pipes to accomplish a CT value of at least 0.1 in the absence of a contacting means. Using a high initial ozone concentration may accomplish a CT of 0.1 in the ozonation system even before the water enters a contacting means, storage tank, or transport pipes. Any design of individual components, and/or any specific layout of the components, falls within the scope of the invention.

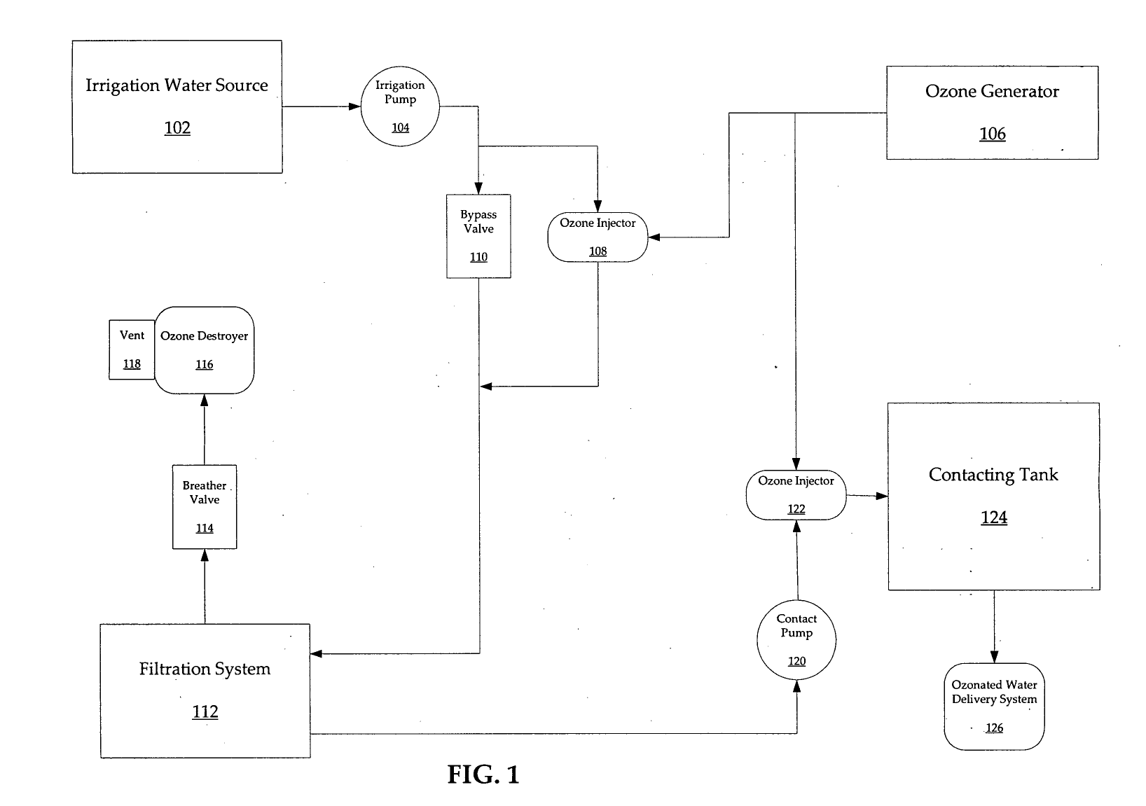

FIG. 1 is a block diagram showing an exemplary system for the disinfection of irrigation water according to the present invention. Irrigation water from source 102 is pumped from the source by a pump 104. Any source and/or pump known in the art may be used. Ozone is made by ozone generator 106, which may be of any type known in the art (such as those that create ozone using ultraviolet light, or using the electrochemistry of water). In some embodiments, ozone generator 106 is a corona discharge generator. Irrigation water flows through a pipe from the pump, and the flow is split so that water is sent either to an ozone injector 108, or to a bypass valve 110. Alternatively, this primary ozonation step may be performed by injecting ozone gas directly into the entire water flow (not shown). Pipes, splitters, valves and other pieces of plumbing or gas transport known in the art may be used anywhere in the system. For example, pipes may be made of concrete, PVC or metal, and may be above or below ground.

The ozone injector 108 may be any kind of ozone injector, such as a venturi injector. The injector 108 may have enough capacity to ozonate the water directly to the desired concentration C, so that an ozone-enriching means, such as a hyperconcentrator, is not needed. A hyperconcentrator also may be included (not shown) so that at least some of the ozonated water is re-ozonated by ozone injector 108. This additional process may further increase the concentration C of ozone in the water. The hyperconcentrator may also include a means for eliminating excess ozone, such as a degas device. Any ozone-enriching means, or means for removal of excess ozone, at any point in the system falls within the scope of the invention.

Irrigation water that has flowed through the bypass valve 110 is combined with ozonated water that has flowed through the ozone injector 108, and the combined flow enters a filtration system 112. The filtration system may be of any type, for example, comprising banks of sand filters. Water may optionally be pumped into the filtration system to supply the pressure needed to move the water through the sand filter beds and also provide water pressure for irrigation (not shown). In addition to its disinfectant properties, dissolved ozone is also a good flocculent, so that some of the smaller biological contaminants that would normally pass through the sand filters may be trapped in the sand bed. Contact between the sand filter bed and the dissolved ozone will also reduce the biological load that can nucleate in the sand filters. Automatic air bleed valves, such as the breather valve 114, are normally found on sand filter systems. Removal of excess ozone from the exhausted air may be achieved by adding an ozone destroyer 116 of any kind, before the exhaust is released into the atmosphere via vent 118.

Ozone gas can also be used in a secondary “polishing” step after sand filtration, to reduce further the number of biological contaminants that may have penetrated the sand filter bed. An additional ozone gas contacting system may be used, comprising a standard venturi contactor, a degassing system, and a contacting tank. Water may be fed into this secondary contacting system by either the sand filter supply pump(s) or additional pump(s) downstream of sand filtration. The contacting tank should be sized to allow for a dissolved ozone gas contacting time of about 30 to 240 seconds or longer, as required to reduce the number of biological contaminants to near-zero levels.

Water exiting the filtration system 112 is sent through a contact pump 120 to another ozone injector 122, such as a venturi injector. Optionally, a static mixer (not shown) may be included after ozone injectors 108 and/or 122. After the second introduction of ozone to the irrigation water via injector 122, the water enters a contacting tank 124.

The contacting tank 124 has a volume V and walls or internal structures that are designed to cause water entering the tank to remain in the tank for at least the minimum time T to achieve a CT value that is greater than 0.1 at a given ozone concentration C. In some embodiments, the volume of the contacting tank is determined in part by the maximum flow rate F of the irrigation water system, the ozone concentration C, and the desired CT value. For example, with F=1500 gallons per minute, C=1 ppm and CT=0.1, the tank volume V should be at least 150 gallons. For a CT of 2 (ppm)(min), the tank volume should be at least 3000 gallons.

It is widely thought that a contact vessel of a volume according to this relationship is sufficient to achieve the desired CT. However, even with a big tank, actual contact times can be too short because of “short circuits” of water flow between a tank's input and output ports. It may be necessary to design the contacting tank 124 to have an outside shape and/or internal structures to ensure that the desired contact times are achieved. An example of a contacting tank design that may be used is described in U.S. Pat. No. 5,968,352, but all kinds of contact tank fall within the scope of the invention.

Ozonated water leaving the contacting tank 124 enters the ozonated water delivery system 126, which may be any system that delivers water from a tank to plants in a field. In an exemplary embodiment, system 126 includes means for spreading the water comprising at least one sprinkler head, or a drip pipe with at least one opening.

In some embodiments, there is no filtration system 112. Such embodiments without filtration are particularly well-suited for a high-flow situation. The water source 102 may be any water source, such as a well having relatively clean water that may still be subject to contamination by microorganisms. An exemplary embodiment of a system using such a source uses side-streaming, which allows smaller flows to be enriched to a high concentration of ozone and then mixed with the main flow. The water flow from the water source 102 is divided into a main flow and at least one side stream. The side stream is ozonated to a high ozone concentration level C1 using a separate pump, a venturi injector and a hyperconcentrator equipped with a degas outlet. The highly ozonated side stream is then re-combined with the main stream, and the ozone is diluted back to the desired level C before being introduced into the contacting tank 124.

In other exemplary embodiments, in place of the contacting tank 124, a length L of pipe with a cross section X may be used, such that the volume LX is equal to the water flow rate F times the CT value divided by the ozone concentration. For example, for a flow of 1500 gallons per minute, a CT value target of 2 and an ozone concentration C of 1 ppm, the volume LX should be 3000 gallons, and thus, for example, a length of about 288 feet of pipe with a cross-section of 16 inches could be used. The contacting pipe may have a variety of configurations, including, but not limited to, a single section or multiple parallel sections coupled together by suitable coupling means such as tee pieces, elbows and custom-designed coupling pieces. The piping may be, for example, PVC piping of a diameter of 10 to 24 inches.

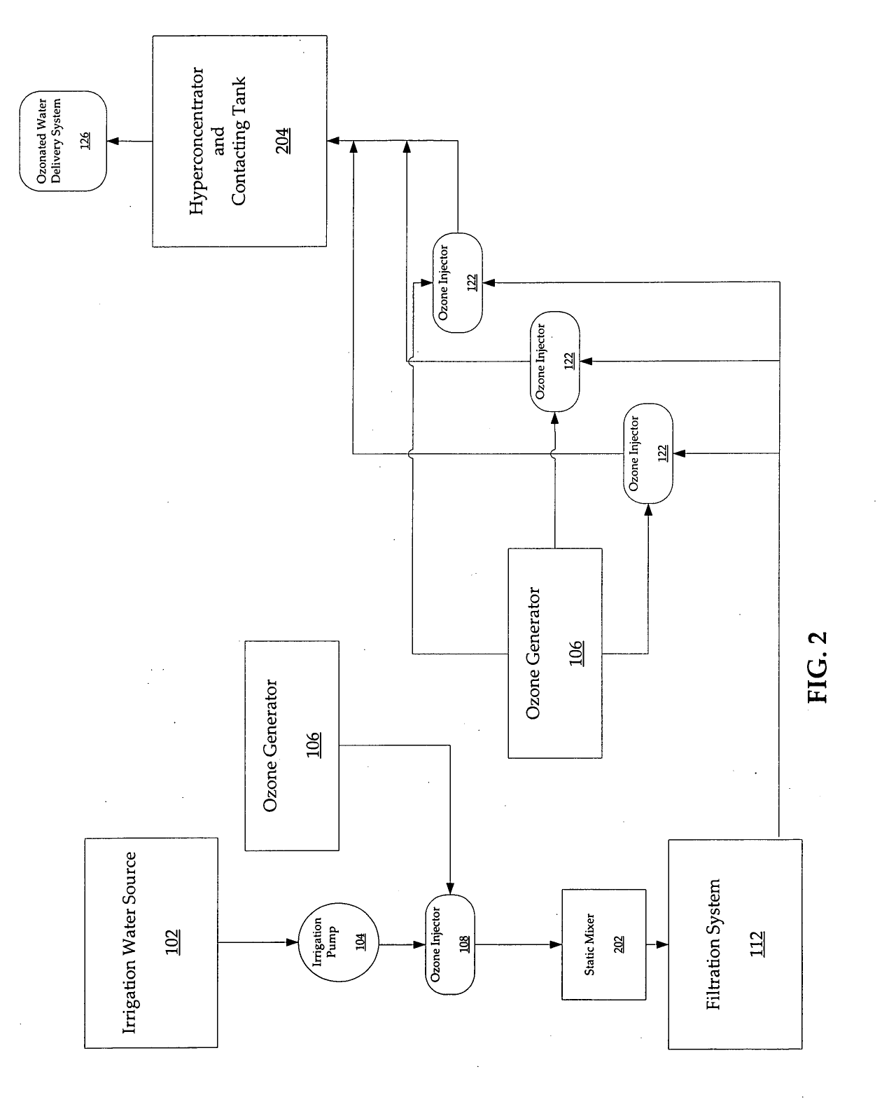

FIG. 2 is a block diagram showing another exemplary system for the disinfection of irrigation water according to the present invention. The irrigation water source 102, irrigation pump 104, ozone generator 106, ozone injector 108, filtration system 112, ozone injector 122, and ozonated water delivery system 126 are as described in FIG. 1. A static mixer 202, discussed above but not shown in FIG. 1, is included in this example immediately upstream of the filtration system 112. Alternatively, all ozone injection may occur downstream of filtration system 112.

Embodiments in which the flow of water from source 102 is split and optionally recombined at any point(s) in the system, as many times as desired, fall within the scope of the invention. In the example shown in FIG. 2, the flow is split into three parallel streams after exiting the filtration system 112, and recombined before or upon entering the hyperconcentrator and contacting tank 204. An additional ozone generator 106 may optionally be used to produce ozone that is injected into the water flowing out of the filtration system 112 by a set of parallel ozone injectors 122, one injecting ozone into each of the parallel streams, as shown. Any number of ozone generators and/or ozone injectors may be used at any point(s) in the system. Additional filters may be included in the system; cleaner water enhances the efficiency of venturi ozone injectors, so that adding more filtration to the system may allow the use of smaller injectors. The contacting tank 204 here includes a hyperconcentrator, as discussed above but not shown in FIG. 1.

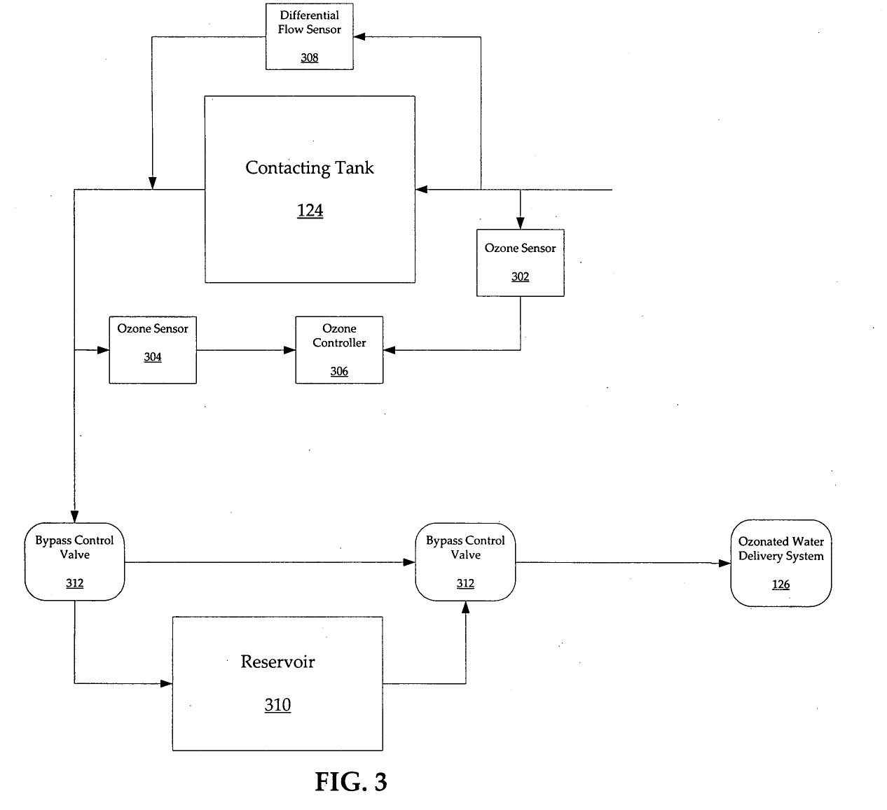

FIG. 3 is a block diagram of an exemplary ozone control system that may be used in some embodiments of the present invention to monitor and adjust the ozone concentration in the water. An ozone concentration sensor 302 may be placed at the input to the contacting tank 124, to measure the ozone concentration and calculate the ozone demand (the amount of ozone needed to ozonate the water to a level C). An ozone concentration sensor 304 may be placed at the output of the contacting tank 124 as well, since the ozone concentration may vary due to differences in the water flow rate before and after the contacting tank 124, or due to differences in the ozone demand before and after contacting.

The output from sensors 302 and/or 304 may be read by an ozone controller 306 in communication with an ozone generator 106 (not shown). The ozone controller 306 can adjust the ozone output of the ozone generator 106 to maintain an ozone concentration C at the output of the contacting tank 124. This feedback mechanism may assure that any organisms in the water in the contacting tank 124 have been exposed to at least the ozone dose CT=C×V/Fₘₐₓ, where V is the volume of the contacting tank 124 and Fₘₐₓ is the maximum flow rate.

A differential water flow sensor 308 may be used to monitor the flow of water entering and leaving the contacting tank 124. The flow sensor 308 may be any kind of flow detector, such as a flow meter or a differential pressure sensor. The flow sensor 308 may be in communication with the ozone controller 306 (communication not shown). Thus, if the flow of water were to fall to zero because of a problem with the irrigation system or the end of the irrigation period, the controller 306 receiving the report of low flow from the sensor 308 may shut off the ozone generator 106 and automatically shut down the rest of the ozonation system. Alternatively, if the flow sensor 308 indicates the presence of a flow, the controller 306 may turn on the ozone generator 106. Flow sensors may be included in the system at any point.

The ozonated water may be diverted to and recovered from a reservoir 310 by one or more bypass control valves 312, for additional contact time between the ozone and the water before delivery to the fields.

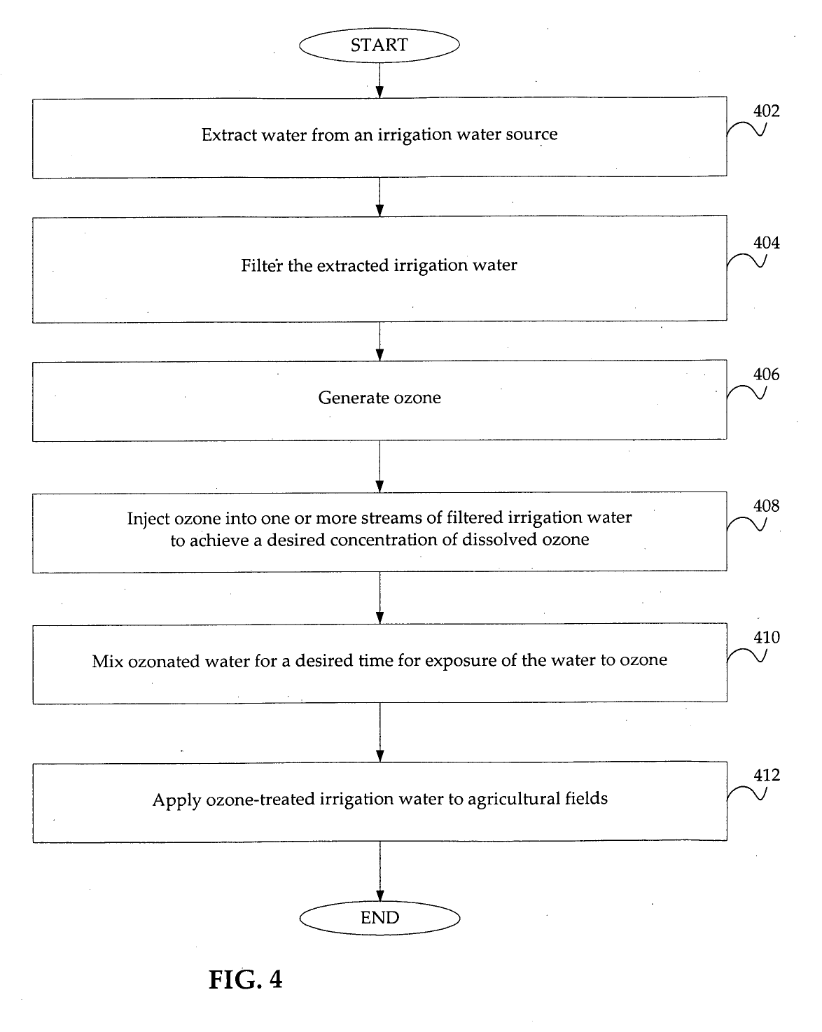

FIG. 4 is a flow chart showing an exemplary method for the disinfection of irrigation water according to the present invention. At step 402, water is extracted from an irrigation source. At step 404, the irrigation water is optionally filtered. At step 406, ozone is generated. At step 408, the generated ozone is injected into one or more streams of filtered irrigation water to achieve a desired concentration of dissolved ozone. One skilled in the art will readily be able to calculate the amount of ozone needed, as described above. At step 410, the ozonated water is mixed for a desired time for exposure of the water to ozone. Mixing may occur in one or more vessels of any kinds, including, but not limited to, a contacting tank and/or pipes, as described above. Also as described above, one skilled in the art will readily be able to calculate the desired time of contact between the water and the dissolved ozone. At step 412, the ozone-treated water is applied to agricultural fields, also as described above.

The exemplary method shown in FIG. 4 may be practiced using a system configured somewhat differently from the exemplary systems depicted in FIGS. 1 and 2. Part of the purpose of FIG. 4 is to illustrate further that embodiments of the invention may involve a multitude of configurations of a variety of numbers and kinds of components herein described.

Embodiments of the present invention provide an effective, safe means of irrigating agricultural fields. An additional benefit of the invention is that it provides a means of preventing microorganisms from growing inside the irrigation system in areas from which they could be flushed into the field even after the water itself is disinfected.

While various embodiments have been described above, it should be understood that they have been presented by way of example only, and not limitation. Thus, the breadth and scope of a preferred embodiment should not be limited by any of the above-described exemplary embodiments.

What is claimed is:

1. A method for disinfecting irrigation water, the method comprising:
generating ozone;
injecting the ozone into a stream of irrigation water until a desired concentration of ozone is obtained; and
applying the ozone-injected water to agricultural fields.

2. The method of claim 1, further comprising filtering the irrigation water before application.

3. The method of claim 1, further comprising mixing the ozone-injected water in a tank to kill bacterial contaminants.

4. The method of claim 1, further comprising hyperconcentrating the ozone by injecting additional ozone into the ozone-injected water.

5. The method of claim 1, further comprising splitting the water flow into one or more side-streams, and wherein injecting the ozone further comprises injecting the ozone into each of the side-streams.

6. The method of claim 1, wherein the step of generating further comprises using a corona discharge generator.

7. The method of claim 1, wherein injecting the ozone further comprises injecting the ozone at least twice.

8. The method of claim 7, wherein injecting the ozone further comprises using one or more ozone injectors.

9. The method of claim 8, wherein injecting the ozone further comprises using a venturi injector.

10. The method of claim 1, further comprising using a static mixer after ozone is injected.

11. The method of claim 1, further comprising monitoring and adjusting the concentration of ozone in the water to a desired level using an ozone control system.

12. A system for disinfecting irrigation water, comprising:
a source of irrigation water;
an ozone generator;
an injector for adding ozone to the water; and
an ozonated water delivery system, configured to deliver ozonated water to agricultural fields.

13. The system of claim 12, further comprising a water filtration system.

14. The system of claim 12, further comprising a contacting tank.

15. The system of claim 12, further comprising a static mixer.

16. The system of claim 12, further comprising an ozone control system for monitoring and adjusting the concentration of ozone in the water to a desired level.

17. The system of claim 16, wherein the ozone control system comprises an ozone concentration sensor.

18. The system of claim 17, wherein the ozone control system further comprises a water flow sensor.

19. The system of claim 16, further comprising a means for venting ozone in excess of the desired level.

20. The system of claim 19, further comprising an ozone destroyer for destroying vented ozone.
